(19) United States
(12) Patent Application Publication
(10) Pub. No.: US 2017/0129377 A1
(43) Pub. Date: May 11, 2017

(54) SHOPPING CART BASKET FLOOR LIFT ATTACHMENT

(71) Applicants: Liborio BARBAGALLO, Hackettstown, NJ (US); Josephine CUOZZO-HEFFERNAN, West Orange, NJ (US)

(72) Inventors: Liborio BARBAGALLO, Hackettstown, NJ (US); Josephine CUOZZO-HEFFERNAN, West Orange, NJ (US)

(21) Appl. No.: 14/935,191

(22) Filed: Nov. 6, 2015

(51) Int. Cl. B60P 1/28; B65G 67/30; B62B 5/00

(52) U.S. Cl. CPC B60P 1/28; B62B 5/00; B65G 67/30

(57) ABSTRACT

A lift assembly for lifting a slide ramp which is positioned on the floor of a basket of a shopping cart. Items for purchase are placed on the slide ramp. The lift assembly is actuated by a hand grip to rotate the slide ramp to an angle from the bottom of the basket. The angled slide ramp slides items placed in the basket to the end of the basket opposite from the handle and allows items placed in the basket to be removed from an end of the basket opposite of the handle.

### BACKGROUND OF THE INVENTION

Field of the Invention

The present invention relates to a lift attachment assembly for lifting a floor of a basket of a shopping cart.

Description of Related Art

Shopping carts are widely used in grocery stores and department stores. Shopping carts typically have a large basket adjacent a handle of the shopping cart. Items to be purchased are placed in the basket. The items are removed from the basket by the consumer and scanned for purchase. The depth of the shopping cart can make it awkward or difficult to retrieve items positioned in the basket, in particular items which are positioned adjacent the handle of the shopping cart.

It is desirable to provide a lift attachment for lifting a ramp which is placed on the floor of the basket of the shopping cart in order to allow items placed in the basket to be removed from an end of the basket opposite of the handle.

### SUMMARY OF THE INVENTION

The present invention relates to a lift assembly for lifting a slide ramp which is positioned on the floor of a basket of a shopping cart. Items for purchase are placed on the ramp. The lift assembly is actuated by a hand grip to rotate the slide ramp to an angle from the bottom of the basket. The angled slide ramp slides items placed in the basket to the end of the basket opposite from the handle and allows items placed in the basket to be removed from an end of the basket opposite of the handle.

The invention will be more fully described by reference to the following drawings.

### BRIEF DESCRIPTION OF THE DRAWINGS

FIG. 1 is a schematic diagram of a shopping cart before installation of a lift assembly in accordance with the teachings of the present invention.

FIG. 2 is an end view of lift lever assembly.

FIG. 3 is a schematic diagram of the lift lever assembly.

FIG. 4 is a schematic diagram of the slide ramp

FIG. 5 is a schematic diagram of a detail of section A shown in FIG. 4.

FIG. 6 is a schematic diagram of a detail of section B shown in FIG. 4

FIG. 7 is a schematic diagram of a lever arm travel limit guide.

FIG. 8 is a schematic diagram of a detail of section C shown in FIG. 7.

FIG. 9 is a schematic diagram of lift lever assembly and slide ramp upon placement in the shopping cart.

FIG. 10 is a schematic diagram of the lift assembly including the lift lever handle and slide ramp before actuation of the lift lever handle.

FIG. 11 is a schematic diagram of the lift assembly after actuation of the lift lever handle.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

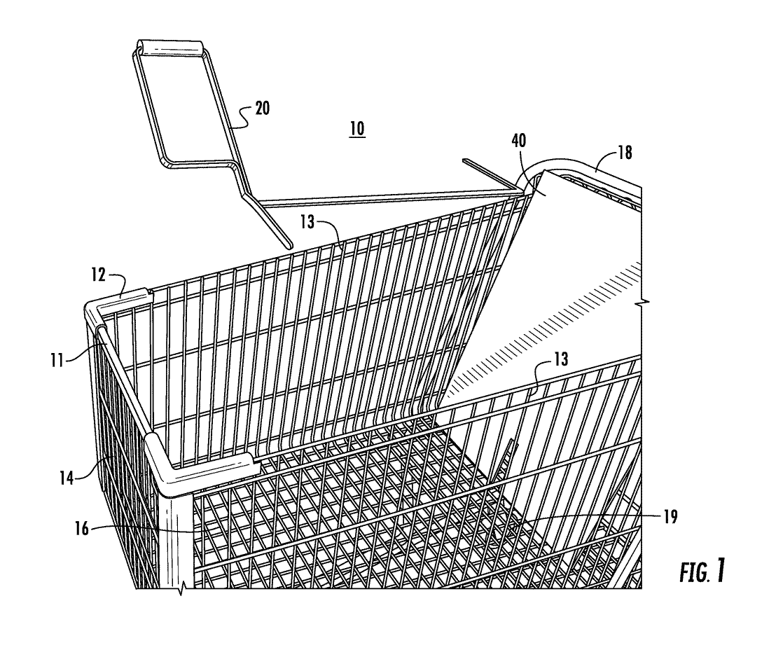

FIG. 1 is a schematic diagram of lift assembly 10 including lift lever assembly 20 and slide ramp 40 before connection to shopping cart 12. Shopping cart 12 includes basket 11. Basket 11 is formed of basket sides 13, basket front 14 and basket floor 16. Frame 17 connects to basket 11, handle 18 and wheels 19.

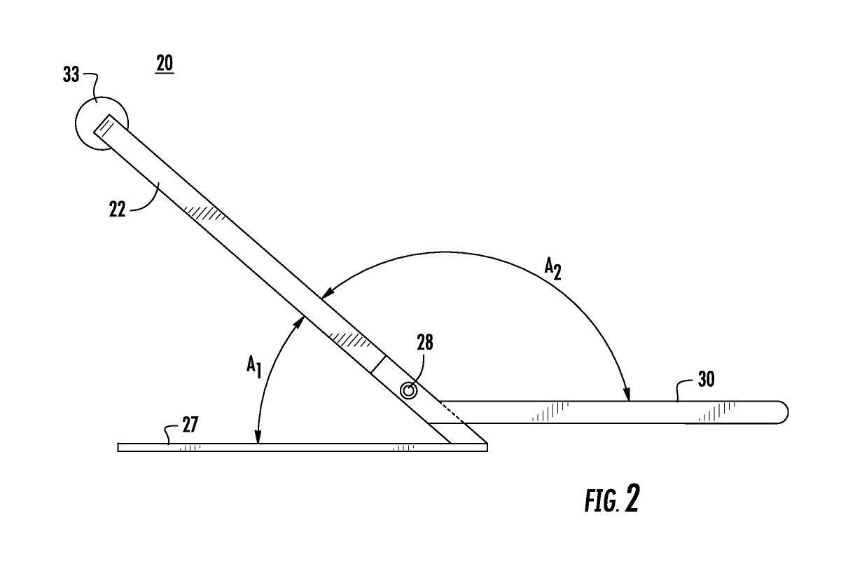

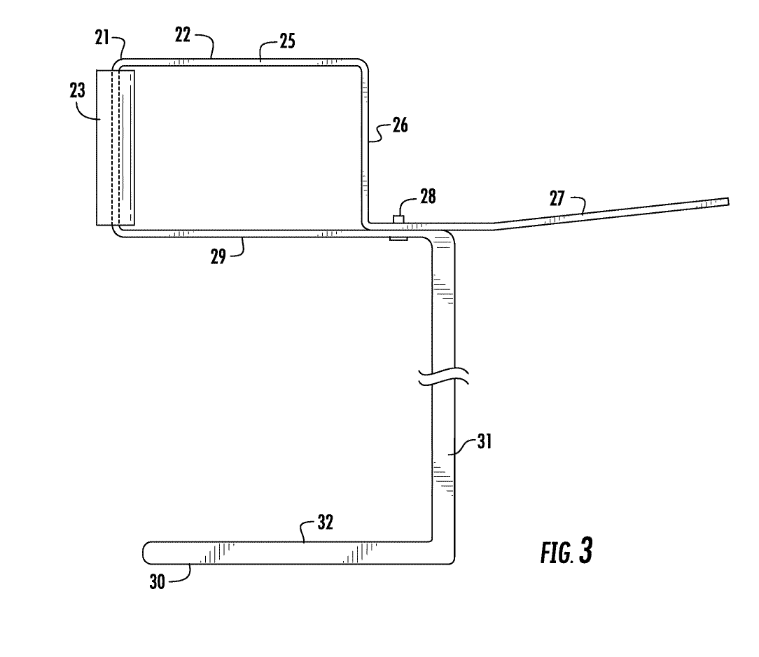

Lift lever assembly 20 includes lift lever handle 22 and slide ramp lift bar 30 as shown in FIGS. 2 and 3. Lift lever hand grip 23 can be placed over front end 21 of lift lever handle 22. Suitable materials for lift lever hand grip 23 include rubber or foam. Sides 24, 25 extend between front end 21 and rear end 26. In one embodiment, front end 21, side 24, side 25 and rear end 26 form a rectangular or square shape for lift lever handle 22. For example, width W₁ of lift lever handle 22 can be in the range of about 4 inches to about 8 inches and preferably W₁ is about 5 inches. Suitable materials for lift lever handle 22 include metal or plastic. In one embodiment lift lever handle 22 is formed of steel. Lift lever handle 22 can include a reflective material on a surface thereof.

Rear end 26 of lift lever handle 22 can be attached or integral with cart return disable bar 27. In one embodiment, rivet 28 connects lift lever handle 22 to cart return disable bar 27. Cart return disable bar 27 is positioned at an angle A₁ from lift lever handle 22. For example, angle A₁ can be in the range of 35 degrees to 90 degrees. Preferably, angle A₁ is 45 degrees.

Slide ramp lift bar 30 can be attached or integral with side 24 or rear end 26 of lift lever handle 22. Slide ramp lift bar 30 is positioned at an angle A₂ from lift lever handle 22. For example, angle A₂ can be in the range of 90 degrees to 145 degrees. Preferably, angle A₂ is 135 degrees. Slide ramp lift bar 30 can have an L-shape between side 31 and support end 32. Slide ramp 40 has a shape adapted to be received on basket floor 16 as shown in FIG. 4.

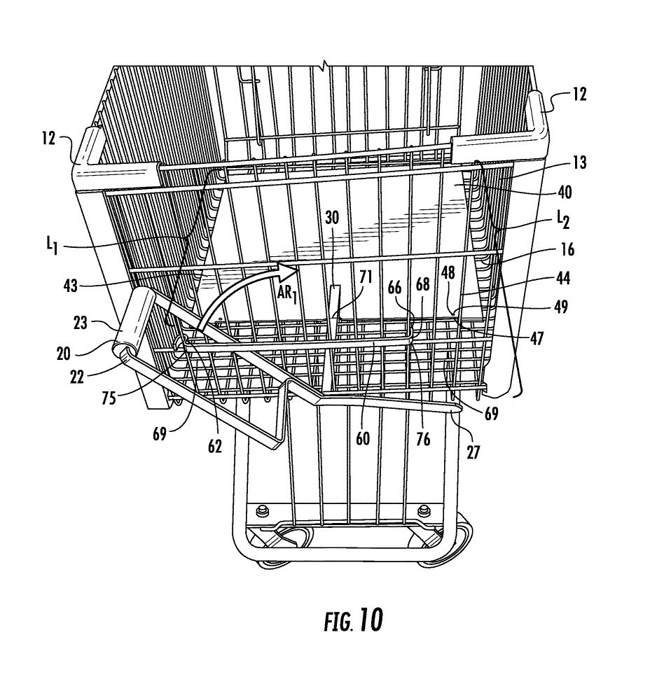

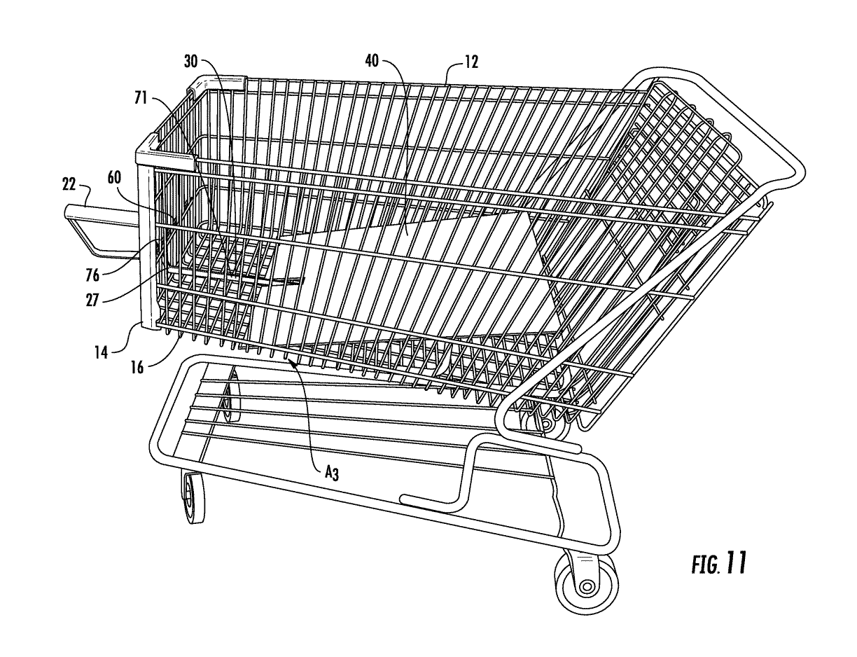

In one embodiment, front end 41 has a smaller width W₂ than width W₃ of rear end 42. For example, front end 41 can be in the range of about 16 to about 20 inches and rear end 42 can be in the range of about 18 to about 24 inches, preferably front end 41 is 18 and a quarter inches and rear end is 20 and a half inches. Length L₁ of side 43 of slide ramp 40 can be smaller than length L₂ of basket side 13 as shown in FIG. 10. It will be appreciated at slide ramp 40 can have a size to fit any conventional shopping cart.

Slide ramp 40 can include tabs 44 at corners 45 as shown in FIGS. 4 and 5. Tabs 44 can slide under rails 47 of basket floor 16 as shown in FIG. 10. Apertures 48 formed at front end 41 of slide ramp 41 can receive split ring 49. For example, apertures 48 can have a 1/8 inch diameter. Tabs 44 and split ring 49 can be used to attach front end 41 to basket floor 16.

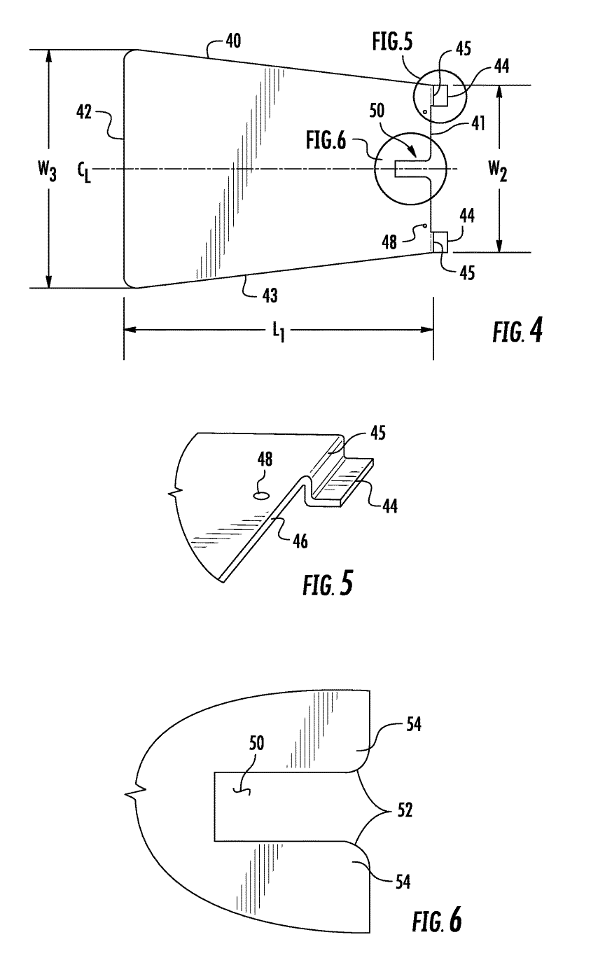

Slide ramp 40 can include guide channel 50 as shown in FIGS. 4 and 6. Guide channel 50 can include rounded edges 52 of front 54 of guide channel 50. For example, guide channel 50 can have a length in the range of about two to about six inches, preferably guide channel 50 has a length of about four inches. Slide ramp lift bar 30 slides within guide channel 50 during raising of slide ramp 40 as shown in FIG. 11.

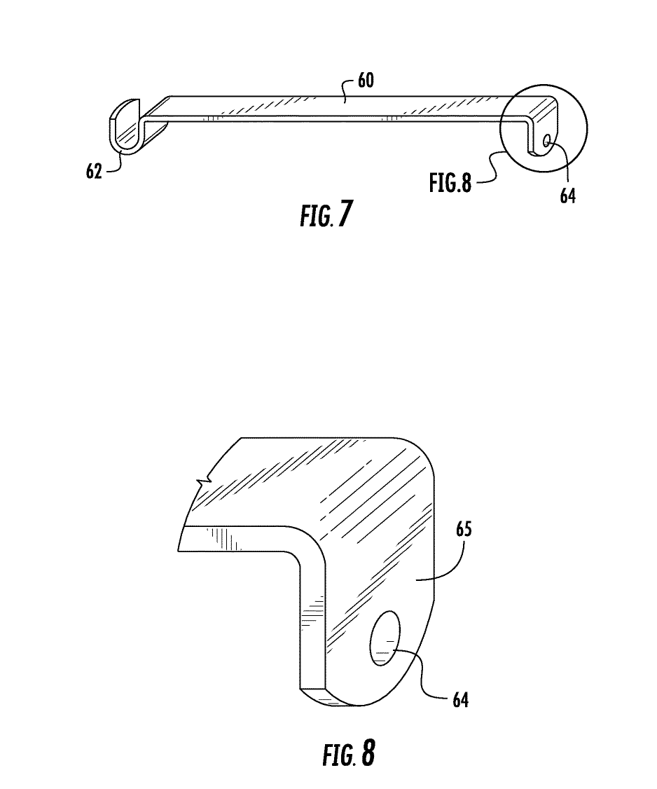

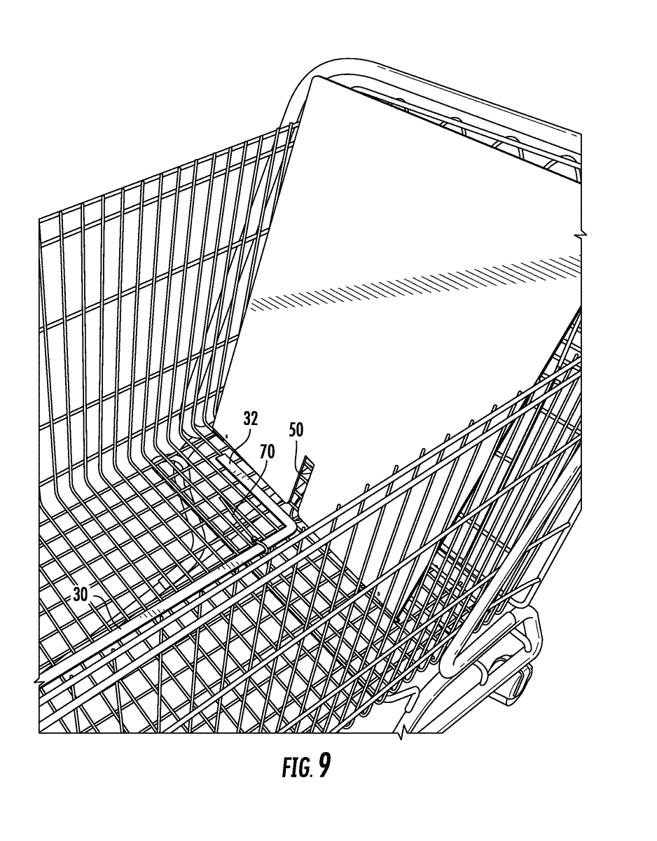

Lever arm travel limit guide 60 is shown in FIGS. 7 and 8. Lever arm travel limit guide 60 can include U-shaped end 62. Protrusion 64 can be positioned at end 65. Protrusion 64 includes aperture 66. U-shaped end 62 can be attached to rail 69 of basket front 14 as shown in FIG. 10. Aperture 66 can receive cotter pin 68. Cotter pin 68 can be received in aperture 66 for attaching lever arm travel limit guide 60 to shopping cart 12. Side 24 of lift lever handle 22 is placed between lever arm travel limit guide 60 and basket front 14.

Referring to FIG. 9, slide ramp lift bar 30 can be rotatably attached to basket floor 16. In one embodiment, slide ramp lift bar 30 is attached with cable tie 70 and cable tie 71 as shown in FIG. 11.

Referring to FIG. 10, lift assembly 10 includes lift lever assembly 20, slide ramp 40 and lever arm travel limit guide 60. Before actuation, lift lever handle 22 is positioned adjacent end 75 of lever arm travel limit guide 60. Support end 32 of slide lever lift bar 30 is flat against basket floor 16 and slide ramp 40 is flat against basket floor 16. Lift lever handle 22 is rotated in direction of arrow AR₁ to rotate slide ramp lift bar 30 and raise slide ramp lift bar 30 to a vertical position and move lift lever handle 22 within lever arm travel limit guide 60 to end 76 of lever arm travel limit guide 60. In this position, support end 32 is rotated to an upright position for raising rear end 42 of slide ramp 40 as shown in FIG. 11. In the actuated position, slide ramp 40 is angled at an angle A₃ from basket floor 16 such that items placed on slide ramp 40 will slide towards basket front 14. For example, angle A₃ can be in the range of about 15 degrees to about 55 degrees and is predetermined by the length of slide ramp lift bar 30. In this position, cart return disable bar 27 is facing downwards in direction D preventing shopping cart 12 from standing with a cart placed at basket front 14. Cart return disable bar 27 can be rotated to rotate slide ramp lift bar 30 and return slide ramp 40 to a position adjacent basket floor 16.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A lift lever assembly adapted to be attached to a shopping cart, the lift lever assembly comprising;
a lift lever assembly including a lift lever handle attached or integral with a slide ramp lift bar, the slide ramp lift bar being positioned at an angle from the lift lever handle; and
a slide ramp having a front and a rear end, the front end of the slide ramp adapted to be coupled to a floor of the shopping cart and the slide ramp lift bar extending to the rear of the slide ramp,
wherein rotation of the lift lever handle rotates the slide ramp lift bar to raise slide ramp bar to an upright position above the floor of the shopping cart and raise rear end of the slide ramp such that the slide ramp is angled from the basket floor.

2. The lift lever assembly of claim 1 further comprising:
a lever arm travel limit guide adapted to be attached to a front of the shopping cart and extends from the shopping cart, a side of the lift lever handle being positioned between the front of the shopping cart and the lever arm travel limit guide,
wherein the lift lever handle is rotated to move lift lever handle from a first end of the lift lever arm travel limit guide to a second end of the lift lever travel limit guide.

3. The lift lever assembly of claim 1 further comprising:
a lever hand grip place over a front end of the lift lever handle.

4. The lift lever assembly of claim 1 wherein the lift lever handle has a square or rectangular shape.

5. The lift lever assembly of claim 1 further comprising:
a cart return disable bar positioned at an angle for the lift lever handle, the cart return disable bar being rotated to return the lift lever handle to a start position and return the rear end of the slide ramp to a position adjacent the basket floor.

6. The lift lever assembly of claim 5 wherein the angle of the cart return disable bar from the lift lever handle is in the range of about 35 to about 90 degrees.

7. The lift lever assembly of claim 5 wherein the angle of the cart return disable bar from the lift lever handle is about 45 degrees.

8. The lift lever assembly of claim 1 wherein the slide ramp lift bar has an L shape between a side of the lift lever handle and a support end of the slide ramp lift bar.

9. The lift lever assembly of claim 1 wherein the angle of the slide ramp lift bar from the lift lever handle is in the range of about 90 to about 145 degrees.

10. The lift lever assembly of claim 1 wherein the angle of the slide ramp lift bar from the lift lever handle is about 135 degrees.

11. The lift lever assembly of claim of claim 1 wherein the slide ramp lift bar is adapted to be rotatably attached to the floor of the shopping cart.

12. The lift lever assembly of claim 11 wherein the slide ramp lift bar is attached with a cable tie.

13. The lift lever assembly of claim 1 wherein the front end of the slide ramp includes a tab at each corner, the tabs adapted to slide under a rail of the floor of the shopping cart.

14. The lift lever assembly of claim 1 wherein the front end of the slide ramp includes one or more apertures, the one or more apertures adapted to receive a split ring for coupling the front end of the slide ramp to the floor of the shopping cart.

15. The lift lever assembly of claim 1 wherein the slide ramp includes a guide channel, the slide ramp lift bar sliding within said guide channel during raising the slide ramp.

16. The lift lever assembly of claim 15 wherein the guide channel includes rounded edges at a front of the guide channel.

17. The lift lever assembly of claim 2 wherein the lever arm travel limit guide includes a first end having a U-shape, said U-shape being adapted to be attached to a rail of the front end of the shopping cart.

18. The lift lever assembly of claim 2 wherein said lever arm travel limit guide includes a second end having a protrusion including aperture therein, a cotter pin is received in the aperture for attaching the lever arm travel limit guide to the front end of the shopping cart.

19. The lift lever assembly of claim 1 wherein the lift lever handle includes a reflective surface.
